(19) United States
(12) Patent Application Publication
(10) Pub. No.: US 2013/0242120 A1
(43) Pub. Date: Sep. 19, 2013

(54) MOTION-STATE CLASSIFICATION FOR CAMERA APPLICATIONS

(71) Applicant: QUALCOMM INCORPORATED, San Diego, CA (US)

(72) Inventors: Subramaniam Venkatraman, Fremont, CA (US); Ruben M. Velarde, Chula Vista, CA (US); Szepo Robert Hung, Carlsbad, CA (US); Carlos M. Puig, Santa Clara, CA (US)

(73) Assignee: QUALCOMM Incorporated, San Diego, CA (US)

(21) Appl. No.: 13/675,957

(22) Filed: Nov. 13, 2012

Related U.S. Application Data
(60) Provisional application No. 61/611,431, filed on Mar. 15, 2012.

(51) Int. Cl. H04N 5/225

(52) U.S. Cl. CPC H04N 5/225
USPC 348/208.4

(57) ABSTRACT

A mobile device uses data from one or more sensors to determine a user context, such as a motion state of the user, and adjusts at least one camera feature selected form a group consisting of continuous auto-focus, auto-white balance, video encode quality, frame rate, search range used for focusing, and exposure mode based on the user context. The user context may include, e.g., at least one of panning, walking, standing, sitting, and traveling in a moving vehicle.

### CROSS-REFERENCE TO PENDING PROVISIONAL APPLICATION

This application claims priority under 35 USC 119 to U.S. Provisional Application No. 61/611,431, filed Mar. 15, 2012 entitled “Inertial Sensor Based Motion-State Classification For Camera Applications,” which is assigned to the assignee hereof and which is incorporated herein by reference.

### BACKGROUND

1. Background Field

Embodiments of the subject matter described herein are related generally to motion classification for a camera, and more specifically for determining a user context and accordingly adjusting a camera feature.

2. Relevant Background

Digital cameras are often used to take both still images and videos. Mobile devices, such as cellular telephones, smart phones, tablet computers, etc., typically include digital cameras capable of both functionalities, i.e., capturing images and videos. Cameras typically include features that are adjusted automatically or manually. For example, continuous auto focus, auto white balance and exposure compensation are all camera features which are modified during image and video capture. These camera features, however, are conventionally adjusted without regard to how the camera is being used by the user.

### SUMMARY

A mobile device uses data from one or more sensors to determine a user context, such as a motion state of the user, and adjusts at least one camera feature based on the user context. For example, camera features that may be adjusted include at least one of continuous auto-focus, auto-white balance, video encode quality, frame rate, search range used for focusing, and exposure mode. The user context may include, e.g., at least one of panning, walking, standing, sitting, and traveling in a moving vehicle.

In one implementation, a method includes receiving data from one or more sensors in a mobile device; determining a user context using the data from the one or more sensors; and adjusting at least one camera feature selected from a group consisting of continuous auto-focus, auto-white balance, video encode quality, frame rate, search range used for focusing, and exposure mode based on the user context.

In one implementation, an apparatus includes a camera capable of capturing images or video streams or both; one or more sensors; and a process coupled to the camera to receive the captured images or video stream and coupled to the one or more sensors to receive sensor data, the processor configured to determining a user context using the sensor data from the one or more sensors, and to adjust at least one camera feature selected from a group consisting of continuous auto-focus, auto-white balance, video encode quality, frame rate, search range used for focusing, and exposure mode based on the user context.

In one implementation, a mobile device includes means for receiving motion data; means for determining a user context using the motion data; and means for adjusting at least one camera feature selected from a group consisting of continuous auto-focus, auto-white balance, video encode quality, frame rate, search range used for focusing, and exposure mode based on the user context.

In one implementation, a storage medium including program code stored thereon, includes program code to receive data from one or more sensors in a mobile device; program code to determine a user context using the data from the one or more sensors; and program code to adjust at least one camera feature selected from a group consisting of continuous auto-focus, auto-white balance, video encode quality, frame rate, search range used for focusing, and exposure mode based on the user context.

### BRIEF DESCRIPTION OF THE DRAWING

FIG. 1 illustrates a mobile device capable of using data from one or more sensors to determine a user context, such as a motion state of the user, and adjusting a camera feature based on the user context.

FIG. 2 is a flow chart illustrating a method of automatically adjusting a camera feature based on the user context determined from sensor data.

FIG. 3 illustrates a flow chart of a method of controlling continuous auto-focus based on the user motion state classification.

FIG. 4 is a flow chart of a method of controlling continuous autofocus based on the user small random types of motion.

FIG. 5 is a flow chart of a method of controlling the auto white balance based on the user motion-state classification.

FIG. 6 is a flow chart of a method of controlling video encode quality based on the user motion-state classification.

FIG. 7 is a flow chart of a method of controlling frame rate based on the user motion-state classification.

FIG. 8 is a flow chart of a method of controlling the search range used for focusing based on the user context.

FIGS. 9A and 9B are flow charts of methods of controlling the exposure mode based on the user context.

FIG. 10 illustrates a system with motion sensors and a classification module.

FIG. 11 illustrates a system for classifying multiple device states.

FIG. 12 is a block diagram of a mobile device capable of using data from one or more sensors to determine a user context, such as a motion state of the user, and adjusting a camera feature based on the user context.

### DETAILED DESCRIPTION

FIG. 1 illustrates a mobile device 100 capable of using data from one or more sensors to determine a user context, such as a motion state of the user, and automatically adjusting at least one of the auto-focus, auto-white balance, video encode quality, frame rate, search range used for focusing, and exposure mode based on the user context.

Digital cameras are often used to take both still images and videos. Mobile devices, such as cellular telephones, smart phones, tablet computers, etc., typically include digital cameras capable of both functionalities, i.e., capturing images and videos. In addition, integrated inertial microelectromechanical systems (MEMS), such as accelerometers and gyroscopes, are now typically found in even low-cost mobile devices, including consumer cameras and smart phones with camera capability. Using inertial sensors in mobile devices, the activity or motion-state of the user may be classified and used to improve the performance of the camera by automatically adjusting appropriate features of the camera.

The integrated motion sensors, such as accelerometers, gyroscopes and magnetometers, can be used to classify activities or motion-states of the user such as being stationary, walking, running and traveling in a moving vehicle. Classification of motion-states may be achieved by recording data generated by the inertial sensors, and performing pattern recognition with the recorded sensor data to find a matching signature for each specific type of motion. For example, walking generates inertial data having a periodic signature that is recognizably different than the inertial data signature produced while running or traveling in a vehicle. Accordingly, such motion-states can be categorized in real-time by pattern recognition with the mobile device. In addition, the pattern recognition process may be further used to recognize when the user is performing a particular action with the camera during a motion state, e.g., the user may be panning the camera to capture a scene while stationary, walking, or traveling in a vehicle.

Once the motion state of the user is classified, the mobile device may adaptively tune parameters of the camera appropriately to improve the user experience. By way of example, camera parameters that may be tuned based on the motion state of the user includes continuous autofocus, auto-white balance, video encode quality, frame rate, search range used for focusing, and exposure mode.

As used herein, a mobile device refers to any portable electronic device that is capable of capturing images and/or video and includes sensors capable of determining motion of the device and may include cameras as well as cellular communication devices or other wireless devices, personal communication system (PCS) devices, personal navigation devices (PND), Personal Information Managers (PIM), Personal Digital Assistant s(PDA), laptops, tablet computers, or other suitable mobile devices.

The mobile device 100 is illustrated as including a housing 101, a display 102, which may be a touch screen display, as well as a speaker 104 and microphone 106. The mobile device 100 includes a camera 110, which includes various adjustable parameters including continuous autofocus, auto-white balance, video encode quality, frame rate, search range used for focusing, and exposure mode. The mobile device 100 is further illustrated as including a number of sensors capable of detecting motion of the mobile device 100. For example, the mobile device 100 may include motion sensors 112, such as three-axis magnetometers and/or linear accelerometers and/or gyroscopes, which may be used to provide information with respect to motion and/or orientation of the mobile device 100. The mobile device 100 may further include a satellite positioning system (SPS) receiver 114 and/or wireless interface 116, which can also be used to provide motion and/or orientation data for the mobile device.

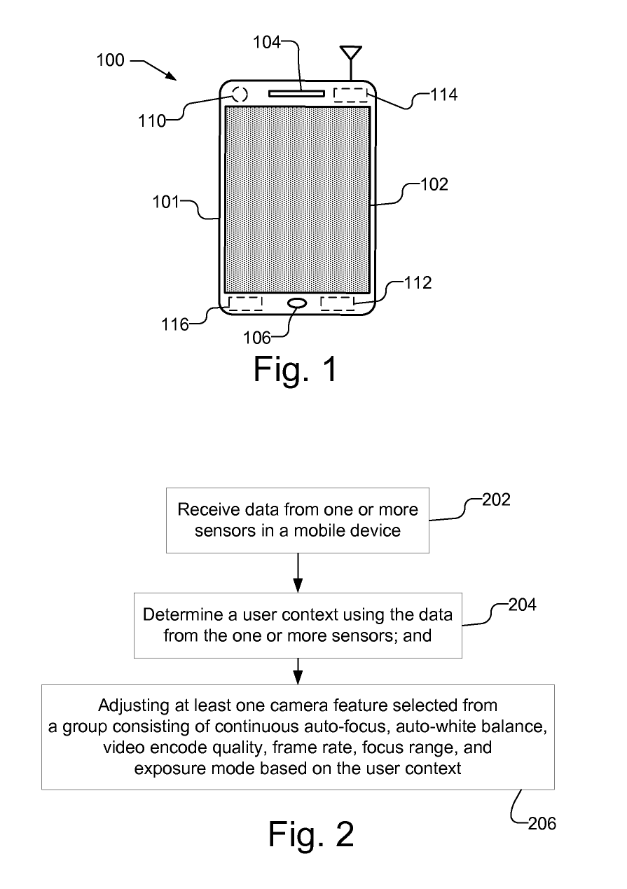

FIG. 2 is a flow chart illustrating a method of automatically adjusting a camera feature based on the user context determined from sensor data. As illustrated, data from one or more sensors is received (202). The data may be from camera 110, motion sensors 112, SPS receiver 114, wireless interface 116, or other sensors that can be used to provide motion and/or orientation data. A user context is determined using the data from the one or more sensors (204). The user context may be a motion state of the user, e.g., whether the user is stationary, walking, running, moving in a vehicle, etc., which may be determined based on data from the sensors, such motion sensors 112. By way of example, the periodic signature from inertial data from motion sensors 112, such as accelerometers, may be used to determine whether the user is walking or running. The motion sensors 112 may further indicate that the user is stationary. Further, if the motion sensors 112 indicate that the user is stationary, while the SPS receiver 114 indicates that that the user is moving, the user may be presumed to be moving in a vehicle. Another type of user context that may be determined is whether the user is inside or outside, e.g., using wireless interface 116, or the general location of the user, e.g., whether the user is at home or work, which may be determined based on data from the SPS receiver 114 and/or wireless interface 116. The user context may further include an activity, such as whether the user is panning the camera or attempting to hold the camera stationary. By way of example, motion sensors 112, such as gyroscopes or magnetometers, may be used to determine if the mobile device 100 is rotating.

At least one camera feature is adjusted selected from a group consisting of continuous auto-focus, auto-white balance, video encode quality, frame rate, search range used for focusing, and exposure mode based on the user context (206).

One example of a camera feature that may be adjusted is continuous auto-focus. Continuous Auto Focus (CAF) has been widely adopted for camcorder applications. For camera applications, CAF has been used sparingly but has become more common. CAF usage for camera applications has not been common due to power consumption requirements. Now that larger displays are utilized, however, CAF is proving to enhance user experience on camera preview and reduce latency for snapshot capture and is thus desirable. Camcorders require a very stable CAF, i.e., minimization of lens movement or focus search is desirable. Cameras, on the other hand, are meant to always be focused and ready for the snapshot capture. Additionally, for cameras the preview stream is not typically stored and it is desirable to capture the “moment” by reducing latency between shutter press and image capture. The use of CAF for camera applications may help to reduce the focus time in the overall snapshot process.

For both camera and camcorder CAF utilization, user motion-state classification may enhance the user experience. For camcorders, motion-state classification can be used to increase CAF stability by reducing false search triggers. For example, it may be desirable to maintain a constant focal distance while a user is walking or panning and refocusing when the user stops walking or is at the end of a pan. Thus, classifying the user context, e.g., classifying different user movements is advantageous; as opposed to merely detecting that the device is in motion. For cameras, classifying user context, such as motion-state, can increase CAF performance by detecting a pan and initiating a refocus soon after the pan is completed.

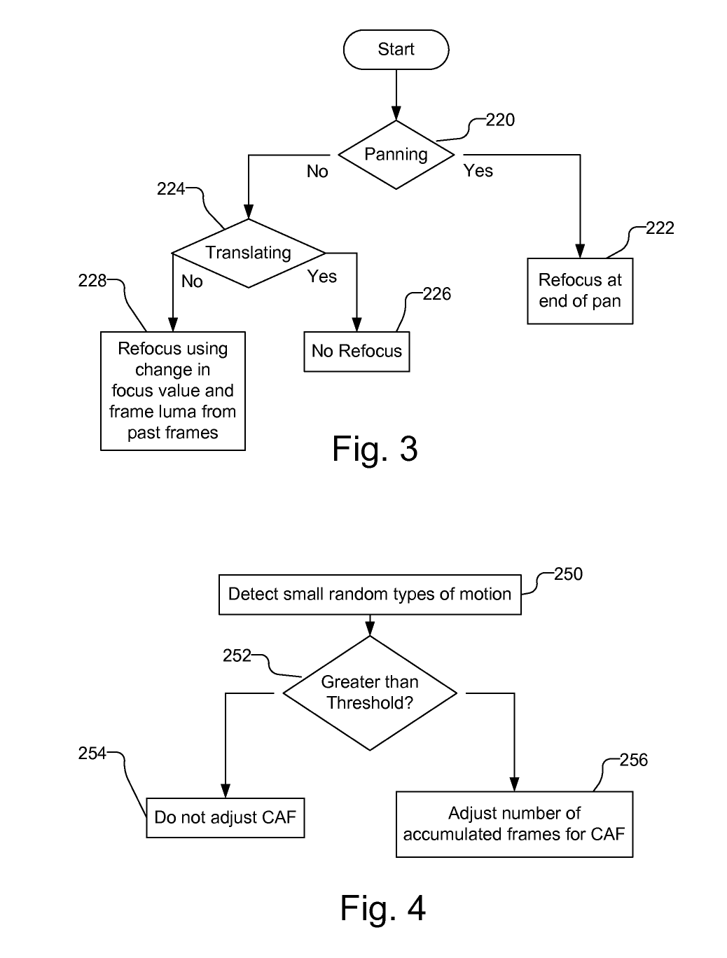

FIG. 3, by way of example, is a flow chart of a method of controlling CAF based on the user motion-state classification, specifically, whether the user is panning and/or translating, e.g., walking or moving in a vehicle. As discussed above, panning may be detected from motion sensors 112, such as gyroscopes or magnetometers, while a motion-state of translating, such as walking or moving in a vehicle may be determined using the periodic signature detected by motion sensors 112, such as accelerometers. As illustrated, when the user context is panning (220), the CAF is automatically adjusted to refocus at the end of the pan (222). Thus, refocusing occurs after panning has stopped, which is useful as a comparison of focus values between a current frame and a previous frames performed by the CAF during panning is not meaningful because the field of view contains different objects.

If the user context is that there is no panning (220), but the user is translating (224), e.g., walking or traveling in a vehicle, the CAF is automatically adjusted so that it does not refocus (226) as it is desirable for the focal position to stay at a fixed depth while moving. When there is no panning (220) and no translating (224), it may be assumed that a change in the focus value and frame luma is based on a scene change, e.g., the object in the image is moving. Accordingly, the CAF is automatically adjusted to refocus using change in the focus value and frame luma, e.g., these parameters are monitored and compared to prior values to detect a condition where refocus should be performed (228), e.g., when in a stable condition or after a wait-time has expired.

The CAF may be automatically adjusted based on other user contexts, such as the amount of small random type of motion, i.e., hand jitter, produced by the user. FIG. 4, by way of example, is a flow chart of a method of controlling CAF based on the user small random types of motion. As illustrated in FIG. 4, small random types of motion, e.g., hand jitter or vibration in a moving vehicle, is detected (250). This type of motion may be detected, e.g., using accelerometers. The detected motion is compared to one or more thresholds (252) to determine if the CAF should be adjusted and if so, by how much. If little motion is detected, the CAF is not adjusted (254), but if the motion is greater than the threshold, the CAF feature is adjusted, e.g., by altering the number of frames used to accumulate focus values for the CAF (254). By accumulating focus values from a few additional frames, the decision for focus search direction can be made more reliably. Thus, instead of sampling focus values from one frame, focus values from additional frames are accumulated before the lens is moved to produce a more reliable decision process. If desired, the number of additional frames used to accumulate focus values may be determined based on a classification of the amount of detected small random type of motion, e.g., by comparing the motion to a number of different thresholds.

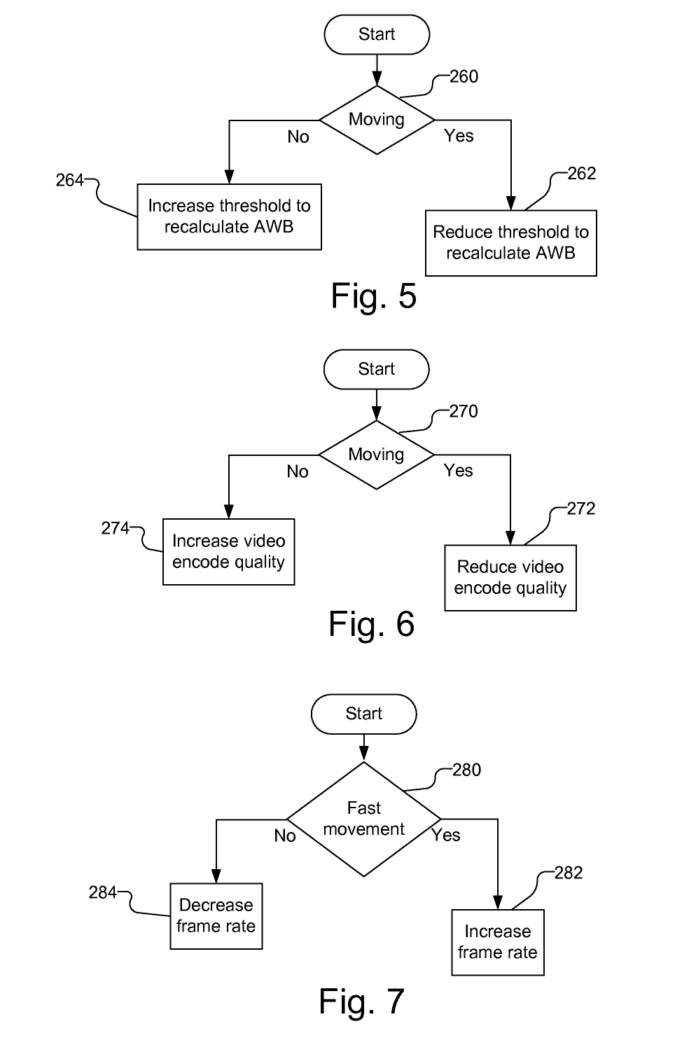

Another example of a camera feature that may be automatically adjusted based on the detected user context is the auto white balance (AWB). FIG. 5, by way of example, is a flow chart of a method of controlling the AWB based on the user motion-state classification. As illustrated when the user context is moving (260), e.g., the user may be walking, running, or traveling in a vehicle, the threshold at which auto white balance is recalculated is reduced (262). When a user is moving, the scene composition may change more rapidly and, thus, it is desirable to reduce the threshold at which auto white balance is recalculated. When the user is not stationary (260), however, the threshold at which the auto white balance is recalculated may be increased (264). Additionally, when panning motion is detected, it may be desirable to automatically recalculate the auto white balance at the end of a pan.

Another example of a camera feature that may be automatically adjusted based on the detected user context is the video encode quality. FIG. 6, by way of example, is a flow chart of a method of controlling video encode quality based on the user motion-state classification. As illustrated when the user context is moving (270), e.g., the user may be walking, running, or traveling in a vehicle, the video encode quality is automatically reduced (272). When a user is moving, there tends to be larger motions in the captured video and thus, the video encode quality decreased without a significantly effect on perceived video quality. Again, the amount of detected movement may be compared to a number of thresholds to determine the amount of the reduction in the video encode quality. By automatically reducing the video encode quality, the size of the vide file is reduced without a perceptible effect on video quality. On the other hand, if the user context is that the user is stationary (270), the video encode quality may be increased (274) or set to a default value.

Another example of a camera feature that may be automatically adjusted based on the detected user context is the video frame rate. FIG. 7, by way of example, is a flow chart of a method of controlling frame rate based on the user motion-state classification. Similar to video encode quality, it may be desirable to increase or decrease the frame rate based on the movement of the user. Thus, as illustrated when the user context is fast movement (280), e.g., the user may be walking, running, or traveling in a vehicle, the frame rate may be automatically increased (282), which is useful to produce realistic fluidity of movement. If a user is moving sufficiently quickly, which may be determined using one or more thresholds, by either translating or panning the camera, consecutive frames may appear to have gaps. By increasing the frame rate, during rapid movement of the user, the apparent gaps may be reduced. On the other hand, if the user is not moving fast, the frame rate may be automatically decreased (284) or left constant.

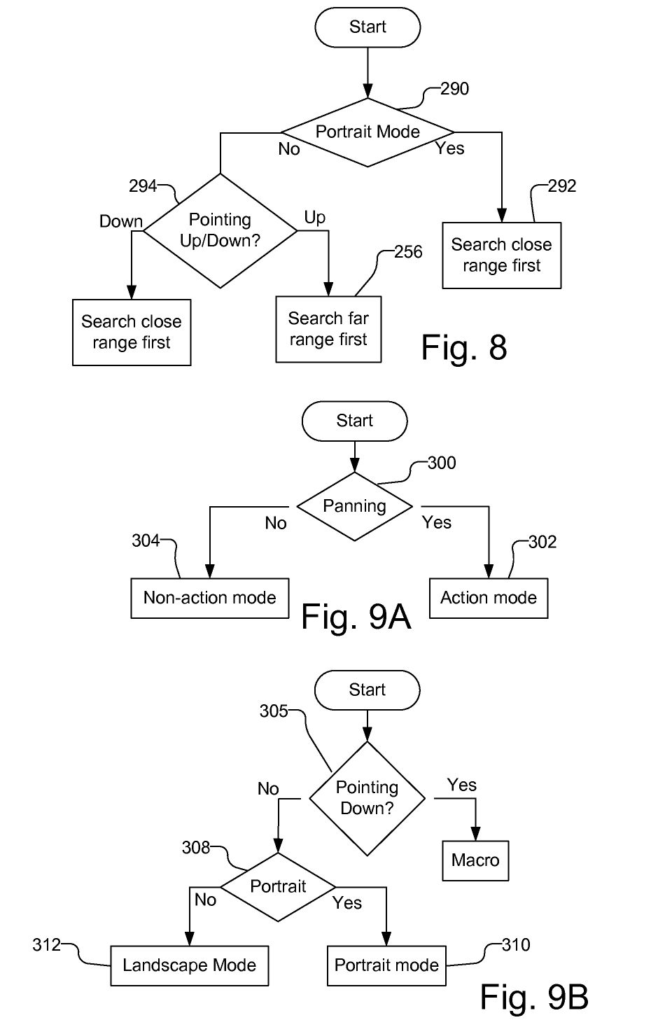

Another example of a camera feature that may be automatically adjusted based on the detected user context is the focus range, i.e., the probable search range used for focusing. The relevant user context for adjusting the search range used for focusing may be, e.g., how the user is holding the camera. For example, whether the user is holding the camera in portrait or landscape mode as well as the perspective angle of the camera can be used to offer a better guess for the most probable range to the object, which may be used to adjust the search range used for focusing. FIG. 8, by way of example, is a flow chart of a method of controlling the search range used for focusing based on the user context. As illustrated, when the user context is holding the camera in portrait mode (290), e.g., as determined by motion sensors 112, the search range for focus is automatically adjusted to search the closer ranges before searching other ranges (292) as the object being imaged is more likely to be near the camera. On the other hand, if the camera is not in portrait mode (290), but the user context is that the camera is held pointing upward (294), the search range for focus is automatically adjusted to search the far ranges before searching other ranges (296) as there is a higher probability that the object being imaged is distant. If the user context is that the camera is not pointed downward (294), the search range for focus is automatically adjusted to search the closer ranges before searching other ranges (296) as there is a higher probability that the object being imaged is near the camera. The direction a camera is pointing, i.e., upwards or downwards, can be determined using an inertial sensor, such as an accelerometer.

Another example of a camera feature that may be automatically adjusted based on the detected user context is the exposure mode. FIG. 9A, by way of example, is a flow chart of a method of controlling the exposure mode in the form of the length of exposure based on the user context. As illustrated, if the user is panning the camera (300), an action mode (302) may be used with an increase in shutter speed to prevent blur due to the camera motion. If the user is not panning the camera, a normal, i.e., non-action mode (304), with a normal shutter speed may be used.

FIG. 9B, by way of example, is another flow chart of a method of controlling the exposure mode based on the user context. As illustrated, if the user pointing the camera downward (305), a macro mode (306) may be used by increasing aperture size. If the camera is not pointed downward (305), and the camera is held in portrait mode (308), a portrait exposure mode (310) may be automatically selected. If the camera is not held in portrait mode (308), a landscape mode (312) may be automatically selected.

States corresponding to particular sensor outputs can be learned such that sensor data can subsequently be used to determine user context. For example, during a training procedure, a device configured to execute a classification algorithm may be exposed to examples of motion states, and may process corresponding sensor data to learn a model for each state. Subsequently, when presented with a new set of sensor information for an unknown motion state, the classifier selects the motion state that has the highest computed likelihoods (or posteriors, if prior probabilities are known).

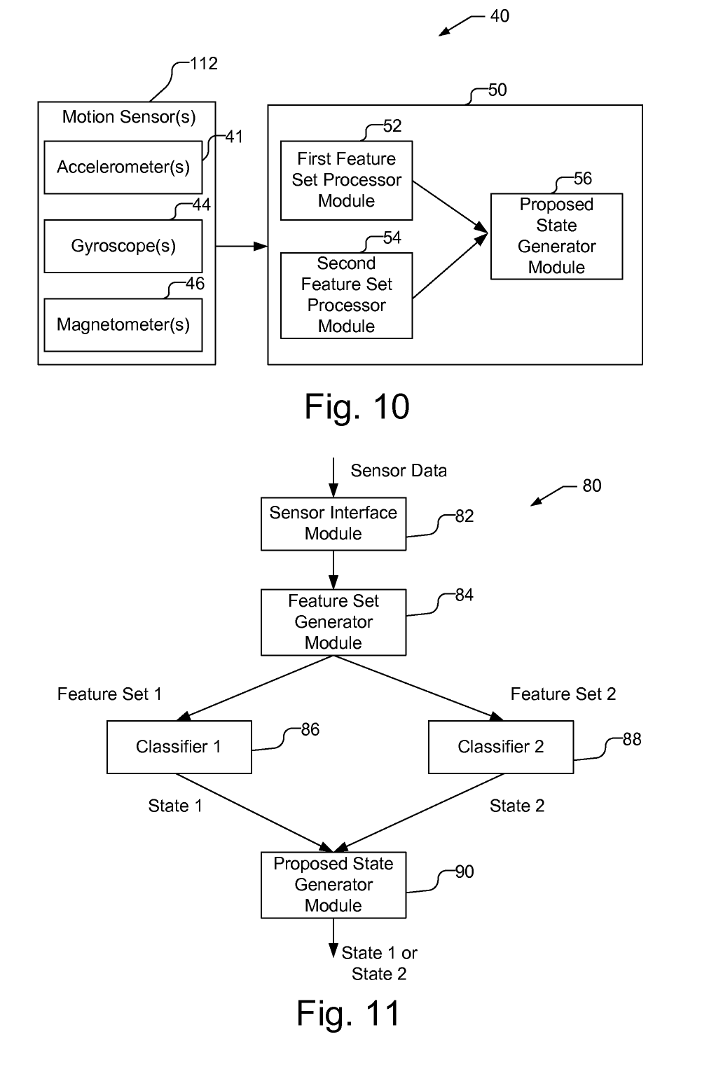

Systems and techniques herein provide for a plurality of classifiers to classify a plurality of device state types. For instance, as illustrated by system 40 in FIG. 10, one or more motion sensors 112 and/or other sensors provide sensor outputs to a classification module 50, which in tum classifies a plurality of device state types represented by the sensor output. To classify a plurality of device state types, a corresponding number of classifiers can be utilized, with each classifier optimized for and outputting a proposed state value for one particular state, e.g., panning, walking, standing, sitting, or traveling in a moving vehicle. Alternatively, separate joint classifiers of multiple device states may be used. For instance, sensor output can be associated with a first feature set and a second feature set, which are classified by a first feature set processor module 52 and a second feature set processor module 54, respectively. Modules 52-54 provide candidate states to a proposed state generator 56, which is configured to generate a proposed and/or estimated device state from the candidate states.

In order to accurately classify device states, the classification algorithms may be trained. For instance, sensor data may be obtained when the user is involved in different activities, and the obtained data can be used to set one or more parameters of the classification algorithms to enable a later determination that sensor information indicates that the motion state is “walking” This “training” may occur before the classifiers are used to classify unknown motion states. In some embodiments, training may occur after initial use. For example, the user may be able to and/or prompted to indicate the value of a particular state type based on inaccurate results, ambiguous results, or other circumstances. Thus, classification of motion-states may be achieved by recording data generated by the inertial sensors, and performing pattern recognition with the recorded sensor data to find a matching signature for each specific type of motion. For example, walking generates inertial data having a periodic signature that is recognizably different than the inertial data signature produced while moving in a vehicle. Accordingly, such motion-states can be categorized in real-time by pattern recognition with the mobile device. The pattern recognition may include supervised and/or unsupervised learning techniques, such as Gaussian mixture models, k-nearest neighbor models and Markov models. In addition, the pattern recognition process may be further used to recognize when the user is performing a particular action with the camera during a motion state, e.g., the user may be panning the camera to capture a scene while stationary or walking.

Referring next to FIG. 11, a system 80 for classifying multiple device states includes a sensor interface module 82 configured to access sensor information of a device (e.g., sensor output generated by one or more sensors). A feature set generator 84 associates respective sensor information indicative of the sensor output with at least a first feature set and a second feature set, such that at least some of the sensor information is associated with the first feature set and at least some of the sensor information is associated with the second feature set.

The first feature set and the second feature set are processed by a first classifier 86 and a second classifier 88, respectively. The first classifier 86 processes the first feature set using a first classification algorithm that is configured to determine a first proposed state of a first state type (e.g., walking) The second classifier 88 processes the second feature set using a second classification algorithm that is configured to determine a second proposed state of the first state type (e.g., panning) Based on the proposed states output by the classifiers 86-88, a proposed state generator module 56 determines a proposed state of the device.

All or part of the modules shown by FIG. 11 can be implemented, wholly or in part, by a classification module 50, as standalone components, etc. For instance, the classification module 50 may implement the functionality of classifiers 86-88 (e.g., via the first feature set processor module 52 and second feature set processor module 54) and proposed generator state module 56. Further, the modules shown in FIGS. 5 and 6 may be implemented in hardware, in software (e.g., by a processor executing instructions in software stored on a memory), or a combination of hardware and software.

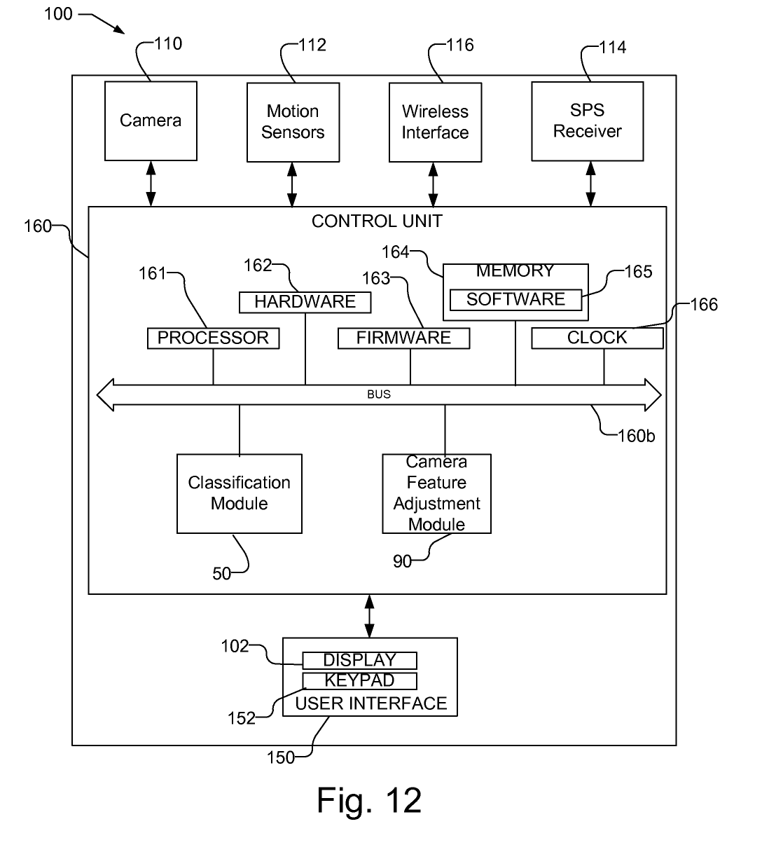

FIG. 12 is a block diagram of a mobile device 100 capable of using data from one or more sensors to determine a user context, such as a motion state of the user, and adjusting a camera feature based on the user context, as described above. The mobile device 100 includes a number of sensors, including motion sensors 112, SPS receiver 114, and wireless interface 116. The mobile device 100 may further include a user interface 150 that includes the display 102, as well as a keypad 152 or other input device through which the user can input information into the mobile device 100. If desired, the keypad 152 may be obviated by integrating a virtual keypad into the display 102 with a touch sensor (or gesture control). Of course, mobile device 100 may include other sensors.

The SPS receiver 114 may be used with any SPS, which are well known, and may include Global Navigation Satellite System (GNSS) such as Global Positioning System (GPS), Galileo, Glonass or Compass. The SPS may also or alternatively include regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems.

The wireless interface 116 may use various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth® network, an IEEE 802.15x, or some other type of network. Moreover, any combination of WWAN, WLAN and/or WPAN may be used.

The mobile device 100 also includes a control unit 160 that is connected to and communicates with the motion sensors 112, SPS receiver 114 and wireless interface 116. The control unit 160 accepts and processes the data provided by the sensors. The control unit 160 may be provided by a bus 160b, processor 161 and associated memory 164, hardware 162, software 165, and 163, and a clock 166. The control unit 160 may include a classification module 50 and a camera feature adjustment module 90.

The classification module 50 and the camera feature adjustment module 90 are illustrated separately from processor 161 for clarity, but may be part of the processor 161 or implemented in the processor based on instructions in the software 165 which is run in the processor 161. It will be understood as used herein that the processor 161 can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile device, and is not to be limited to any particular type of memory or number of memories, or type of media upon which memory is stored.

The methodologies described herein may be implemented by various means depending upon the application. For example, these methodologies may be implemented in hardware 162, firmware 163, software 165, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 164 and executed by the processor 161. Memory may be implemented within or external to the processor 161. If implemented in firmware and/or software, the functions may be stored as one or more instructions or code on a storage medium that is computer-readable, wherein the storage medium does not include transitory propagating signals. Examples include storage media encoded with a data structure and storage media encoded with a computer program. Storage media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Thus, a mobile device includes a means for means for receiving motion data, which may include, e.g., the motion sensors 112, as well as other sensors such as the SPS receiver 114 and wireless interface 116. Means for determining a user context using the motion data may include the classification module 50 or processor 161, and means for adjusting a camera feature comprising at least one of continuous auto-focus, auto-white balance, video encode quality, frame rate, search range used for focusing, and exposure mode based on the user context may include, e.g., the camera feature adjustment module 90 or processor 161.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A method comprising:
receiving data from one or more sensors in a mobile device;
determining a user context using the data from the one or more sensors; and
adjusting at least one camera feature selected from a group consisting of continuous auto-focus, auto-white balance, video encode quality, frame rate, search range used for focusing, and exposure mode based on the user context.

2. The method of claim 1, wherein determining the user context using the data from the one or more sensors comprises classifying a motion state.

3. The method of claim 1, wherein the user context comprises at least one of panning, walking, standing, sitting, and traveling in a moving vehicle.

4. The method of claim 3, wherein adjusting the at least one camera feature based on the user context comprises controlling continuous auto-focus to adjust according to at least one of the following:
not auto-focusing when the user context is walking and not panning;
auto-focusing when panning stops when the user context is walking and panning; and
auto-focusing when panning stops when the user context is not walking and panning.

5. The method of claim 3, wherein adjusting the at least one camera feature based on the user context comprises reducing a threshold at which auto white balance is recalculated when the user context is walking, panning, or traveling in a moving vehicle.

6. The method of claim 1, wherein when the user context is panning, adjusting the at least one camera feature based on the user context comprises recalculating auto white balance at an end of a pan.

7. The method of claim 3, wherein adjusting the at least one camera feature based on the user context comprises decreasing video encode quality when the user context is walking or panning.

8. The method of claim 3, wherein adjusting the at least one camera feature based on the user context comprises increasing frame rate when the user context is walking, running or traveling in a vehicle.

9. The method of claim 3, wherein adjusting the at least one camera feature based on the user context comprises increasing shutter speed when the user context is panning.

10. The method of claim 1, wherein determining the user context using the data from the one or more sensors comprises classifying how a user is holding the mobile device, and wherein adjusting the at least one camera feature based on the user context comprises increasing aperture size when the user context is pointing the camera downward.

11. The method of claim 1, wherein determining the user context using the data from the one or more sensors comprises classifying how a user is holding the mobile device, and wherein the camera feature that is adjusted is a probable search range for focusing.

12. The method of claim 1, wherein determining the user context using the data from the one or more sensors comprises classifying an amount of hand jitter, and wherein the camera feature that is adjusted is a number of frames used to accumulate focus values for continuous auto-focus.

13. The method of claim 1, wherein the one or more sensors are motion sensors.

14. The method of claim 1, wherein the one or more sensors comprises at least one of accelerometers, gyroscopes, and magnetometers.

15. The method of claim 1, wherein the one or more sensors comprises at least one of a satellite positioning system receiver and a wireless interface.

16. An apparatus comprising:
a camera capable of capturing images or video streams or both;
one or more sensors; and
a processor coupled to the camera to receive captured images or a video stream and coupled to the one or more sensors to receive sensor data, the processor configured to determining a user context using the sensor data from the one or more sensors, and to adjust at least one camera feature selected from a group consisting of continuous auto-focus, auto-white balance, video encode quality, frame rate, search range used for focusing, and exposure mode based on the user context.

17. The apparatus of claim 16, wherein the processor is configured to determine the user context using the sensor data by being configured to classify a motion state.

18. The apparatus of claim 16, wherein the user context comprises panning, walking, standing, sitting, and traveling in a moving vehicle.

19. The apparatus of claim 18, wherein the processor is configured to adjust the at least one camera feature based on the user context by being configured to control continuous auto-focus to adjust according to at least one of the following:
not auto-focus when the user context is walking and not panning;
auto-focus when panning stops when the user context is walking and panning;
auto-focus when panning stops when the user context is not walking and panning.

20. The apparatus of claim 18, wherein the processor is configured to adjust the at least one camera feature based on the user context by being configured to reduce a threshold at which auto white balance is recalculated when the user context is walking, panning, or traveling in a moving vehicle.

21. The apparatus of claim 16, wherein when the user context is panning, the processor is configured to adjust the at least one camera feature based on the user context by being configured to recalculate auto white balance at an end of a pan.

22. The apparatus of claim 18, wherein the processor is configured to adjust the at least one camera feature based on the user context by being configured to decrease video encode quality when the user context is walking or panning.

23. The apparatus of claim 18, wherein the processor is configured to adjust the at least one camera feature based on the user context by being configured to increase frame rate when the user context is walking, running or traveling in a vehicle.

24. The apparatus of claim 18, wherein the processor is configured to adjust the at least one camera feature based on the user context by being configured to increase shutter speed when the user context is panning.

25. The apparatus of claim 16, wherein the processor is configured to determine the user context using the sensor data by being configured to classify how a user is holding the apparatus, and wherein the processor is configured to adjust the at least one camera feature based on the user context by being configured to increase aperture size when the user context is pointing the camera downward.

26. The apparatus of claim 16, wherein the processor is configured to determine the user context using the sensor data by being configured to classify how a user is holding the apparatus, and wherein the processor is configured to adjust the at least one camera feature based on the user context by being configured to adjust a probable search range for focusing.

27. The apparatus of claim 16, wherein the processor is configured to determine the user context using the sensor data by being configured to classify an amount of hand jitter, and wherein the processor is configured to adjust the at least one camera feature based on the user context by being configured to adjust a number of frames used to accumulate focus values for continuous auto-focus.

28. The apparatus of claim 16, wherein the one or more user sensors comprise at least one of accelerometers, gyroscopes, and magnetometers.

29. The apparatus of claim 16, wherein the one or more user sensors comprise at least one of a satellite positioning system receiver and a wireless interface.

30. A mobile device comprising:
means for receiving motion data;
means for determining a user context using the motion data; and
means for adjusting at least one camera feature selected from a group consisting of continuous auto-focus, auto-white balance, video encode quality, frame rate, search range used for focusing, and exposure mode based on the user context.

31. The mobile device of claim 30, wherein determining the user context using the motion data comprises classifying a motion state.

32. The mobile device of claim 30, wherein the user context comprises at least one of panning, walking, standing, sitting, and traveling in a moving vehicle.

33. The mobile device of claim 32, wherein the means for adjusting the at least one camera feature based on the user context controls a continuous auto-focus to adjust according to at least one of the following:
not auto-focus when the user context is walking and not panning;
auto-focus when panning stops when the user context is walking and panning;
auto-focus when panning stops when the user context is not walking and panning.

34. The mobile device of claim 32, wherein the means for adjusting the at least one camera feature based on the user context reduces a threshold at which auto white balance is recalculated when the user context is walking, panning, or traveling in a moving vehicle.

35. The mobile device of claim 30, wherein when the user context is panning, the means for adjusting the at least one camera feature based on the user context recalculates auto white balance at an end of a pan.

36. The mobile device of claim 32, wherein the means for adjusting the at least one camera feature based on the user context decreases video encode quality when the user context is walking or panning.

37. The mobile device of claim 32, wherein the means for adjusting the at least one camera feature based on the user context increases frame rate when the user context is walking, running or traveling in a vehicle.

38. The mobile device of claim 32, wherein the means for adjusting the at least one camera feature based on the user context increases shutter speed when the user context is panning.

39. The mobile device of claim 30, wherein the means for determining the user context classifies how a user is holding the mobile device, and wherein the camera feature that is adjusted is an aperture size when the user context is pointing the camera downward.

40. The mobile device of claim 30, wherein the means for determining the user context classifies how a user is holding the mobile device, and wherein the camera feature that is adjusted is a probable search range for focusing.

41. The mobile device of claim 30, wherein the means for determining the user context classifies an amount of hand jitter, and wherein the camera feature that is adjusted is a number of frames used to accumulate focus values for continuous auto-focus.

42. A storage medium including program code stored thereon, comprising:
program code to receive data from one or more sensors in a mobile device;
program code to determine a user context using the data from the one or more sensors; and
program code to adjust at least one camera feature selected from a group consisting of continuous auto-focus, auto-white balance, video encode quality, frame rate, search range used for focusing, and exposure mode based on the user context.

43. The storage medium of claim 42, wherein the program code to determine the user context using the data from the one or more sensors classifies a motion state.

44. The storage medium of claim 42, wherein the user context comprises at least one of panning, walking, standing, sitting, and traveling in a moving vehicle.
